(19) United States
(12) Patent Application Publication
(10) Pub. No.: US 2019/0106800 A1
(43) Pub. Date: Apr. 11, 2019

(54) CONNECTING COMPONENT MATERIAL

(71) Applicant: NISSHIN STEEL CO., LTD., Tokyo (JP)

(72) Inventors: Yoshikatsu NISHIDA, Tokyo (JP); Masashi HIRAOKA, Tokyo (JP); Masao NAGAO, Tokyo (JP); Takahiro FUJII, Tokyo (JP)

(73) Assignee: NISSHIN STEEL CO., LTD., Tokyo (JP)

(21) Appl. No.: 16/088,984

(22) PCT Filed: Feb. 22, 2017
(86) PCT No.: PCT/JP2017/006530

§ 371 Date: Sep. 27, 2018

(30) Foreign Application Priority Data
Mar. 31, 2016 (JP) 2016-069993

(51) Int. Cl. C25D 5/10; C25D 3/30; C25D 3/38; C25D 7/00; H01R 13/03; H01R 43/16

(52) U.S. Cl. CPC C25D 5/10; C25D 3/30; H01R 43/16; C25D 7/00; H01R 13/03; C25D 3/38

(57) ABSTRACT

Disclosed is a connection component material that can be used, for example, for electrical contact components, such as connectors, lead frames, and harness plugs, used in electrical devices, electronic devices, etc. The connection component material comprises a Cu plating layer formed on a surface of a stainless steel plate, and a Sn plating layer formed on the Cu plating layer, the connection component material being characterized in that: the amount of adhesion of the Cu plating layer is from 1.5 to 45 g/m²; the amount of adhesion of the Sn plating layer is from 1.5 to 15 g/m²; and the surface hardness of the stainless steel plate is from 200 to 400 HV.

### TECHNICAL FIELD

The present invention relates to a connecting component material. More specifically, the present invention relates to a material for a connecting member which can be suitably used in, for example, electrical contact members such as a connector, a lead frame and a harness plug, which are used in an electrical instrument, an electronic instrument, and the like. The material for a connecting member of the present invention makes it possible to suppress increase in contact resistance, even when fine sliding of a connecting member is repeated after the connecting member is fitted to another connecting member such as an electrical connecting terminal. The material for a connecting member of the present invention can therefore increase reliability of electrical connection.

### BACKGROUND ART

The number of connecting terminals which are used in an automobile, a mobile phone and the like tends to be increased in accordance with increase of the number of electronic control devices to be used therein. It has been required for the connecting terminal to be miniaturized and lightened from the viewpoint of improvement in fuel efficiency of an automobile, space saving, portability of a mobile phone and the like. In order to respond to these requirements, it is necessary that the connecting terminal is prevented from deformation due to force (insertion force) which is applied when the connecting terminal is fitted to another connecting terminal, that the connecting terminal is miniaturized, and that contact pressure between the connecting terminals is maintained at their connected portion. Accordingly, it has been required for the connecting terminal to use a material having strength higher than a copper alloy which has hitherto been used.

As a material having strength higher than the copper alloy, a stainless steel plate is considered to be used. The stainless steel plate is suitable from the viewpoint of miniaturization, lightening and reduction in cost, since the stainless steel plate has mechanical strength higher than the copper alloy, and is small in specific gravity and inexpensive.

As a material for an electrical contact member, a stainless steel plate on which a metal different from the stainless steel is plated has been developed in order to reduce contact resistance of the surface of the stainless steel plate (see, for example, Patent Literatures 1 to 3). According to an electrical contact member in which the stainless steel plate having a plated layer made of a metal different from the stainless steel is used, the plated layer is worn away at an early stage, and the stainless steel plate used as a base material is exposed to the outside, when vibrations are applied to the electrical contact member, and fine sliding is repeated at a contact portion. Therefore, a contact resistance is increased at the contact portion. Accordingly, it has been desired to develop a material for a connecting member which can suppress increase in contact resistance even when fine sliding is repeated at the contact portion.

### PRIOR ART LITERATURES

### Patent Literatures

Patent Literature 1: Japanese Patent Unexamined Publication No. 2004-300489

Patent Literature 2: Japanese Patent Unexamined Publication No. 2007-262458

Patent Literature 3: Japanese Patent Unexamined Publication No. 2015-028208

### SUMMARY OF THE INVENTION

### Problems to be Solved by the Invention

The present invention has been made in view of the above-mentioned prior arts. An object of the present invention is to provide a material for a connecting member used as a raw material of a connecting member, which can suppress increase in contact resistance even when fine sliding of a connecting member is repeated.

### Means for Solving the Problems

The present invention relates to:

(1) a material for a connecting member used as a raw material of a connecting member, which includes a Cu plating layer formed on a surface of a stainless steel plate, and a Sn plating layer formed on the Cu plating layer, wherein the deposition amount of the Cu plating layer is 1.5 to 45 g/m²; the deposition amount of the Sn plating layer is 1.5 to 15 g/m²; and the surface hardness of the stainless steel plate is 200 to 400 HV; and
(2) a process for producing a material for a connecting member used as a raw material of a connecting member, which includes forming a Cu plating layer on a surface of a stainless steel plate having a surface hardness of 200 to 400 HV so that the deposition amount of the Cu plating layer is 1.5 to 45 g/m², and forming a Sn plating layer on the Cu plating layer so that the deposition amount of the Sn plating layer is 1.5 to 15 g/m².

### Effects of the Invention

According to the present invention, there can be provided a material for a connecting member, which can suppress increase in contact resistance even when fine sliding of a connecting member is repeated.

### BRIEF DESCRIPTION OF DRAWINGS

FIG. 1 is a schematic explanatory view of an apparatus for examining abrasion resistance in fine sliding, used in each working example and each comparative example.

FIG. 2 (a) is an X-ray diffraction pattern of a plating layer of a material for a connecting member obtained in Example 1, and FIG. 2 (b) is an X-ray diffraction pattern of a plating layer of a material for a connecting member obtained in Example 3.

### MODE FOR CARRYING OUT THE INVENTION

As described above, the material for a connecting member of the present invention is a material which is used as a raw material of a connecting member. The material for a connecting member includes a Cu plating layer formed on a surface of a stainless steel plate, and a Sn plating layer formed on the Cu plating layer, wherein the deposition amount of the Cu plating layer is 1.5 to 45 g/m²; the deposition amount of the Sn plating layer is 1.5 to 15 g/m²; and the surface hardness of the stainless steel plate is 200 to 400 HV.

Since the material for a connecting member of the present invention has the above-mentioned structure, the material is excellent in a property for suppressing increase in contact resistance even when fine sliding of the connecting member is repeated (hereinafter, this property is referred to as abrasion resistance in fine sliding).

The material for a connecting member of the present invention can be produced by, for example, forming a Cu plating layer on a surface of a stainless steel plate having a surface hardness of 200 to 400 HV so that the deposition amount of the Cu plating layer is 1.5 to 45 g/m², and forming a Sn plating layer on the Cu plating layer so that the deposition amount of the Sn plating layer is 1.5 to 15 g/m².

Examples of the stainless steel plate include plates of stainless steel prescribed in JIS (Japanese Industrial Standards), such as plates of austenitic stainless steel such as SUS301, SUS304 and SUS316; plates of ferritic stainless steel such as SUS430, SUS430LX and SUS444; plates of martensitic stainless steel such as SUS410 and SUS420; and the like. The present invention is not limited only to those exemplified ones.

The thickness, length and width of the stainless steel plate are not particularly limited, respectively, and can be appropriately adjusted in accordance with the kind of the stainless steel plate, uses of the material for a connecting member, and the like. One example of the thickness of the stainless steel plate includes 50 μm to 0.5 mm or so.

The surface hardness of the stainless steel plate is 200 HV or more from the viewpoint of suppression of lowering of abrasion resistance in fine sliding due to increase of contact resistance caused by oxidation of the stainless steel plate, which is exposed to the surface by plastic flow of the Cu plating layer due to shear stress during sliding, and 400 HV or less from the viewpoint of suppression of abrasion due to slight plastic deformation of the stainless steel plate caused by shear stress during sliding and plastic flow of the Cu plating layer during sliding, and suppression of lowering of abrasion resistance in fine sliding due to exposure of the stainless steel plate to the surface. The surface hardness of the stainless steel plate can be easily controlled by conducting annealing, cold rolling or the like to the stainless steel plate.

The surface hardness of the stainless steel plate means a Vickers hardness (HV) of the surface of the stainless steel plate, and is a hardness as determined by using a Micro Vickers Hardness Tester (product number: HM-221) commercially available from Mitutoyo Corporation. The specific method for determining the surface hardness of the stainless steel plate is described in the following working examples.

Incidentally, a Ni plating layer can be formed on the surface of the stainless steel plate from the viewpoint of increase in adhesion of the stainless steel plate and the Cu plating layer within a scope which would not hinder an object of the present invention. The Ni plating layer can be formed by means of, for example, Ni plating, Ni strike plating, and the like. The Ni plating and the Ni strike plating can be carried out by an electroplating method or an electroless plating method. The electroplating method includes, for example, an electroplating method using a Wood's bath, an electroplating method using a Watts bath, an electroplating method using a sulfamic acid bath and the like, and the present invention is not limited only to those exemplified ones. When the Ni plating layer is formed on the stainless steel plate, the adhesion amount of the Ni plating layer is preferably 0.4 g/m² or more, and more preferably 0.9 g/m² or more, from the viewpoint of increase in adhesion of the stainless steel plate and the Cu plating layer, and preferably 4 g/m² or less, and more preferably 3 g/m² or less, from the viewpoint of increase in adhesion of the stainless steel plate and the Cu plating layer.

A method for forming a Cu plating layer on the stainless steel plate includes an electroplating method and an electroless plating method. The Cu plating layer can be formed by any of these methods in the present invention. The electroplating method includes, for example, an electroplating method using a copper sulfate bath including copper sulfate and sulfuric acid, and as occasion demands, chlorine ion, a plating inhibitor, a plating accelerator and the like, and the present invention is not limited only to the exemplified method. The adhesion amount of the Cu plating layer is 1.5 to 45 g/m² from the viewpoint of improvement in abrasion resistance in fine sliding.

A method for forming a Sn plating layer on the Cu plating layer formed on the stainless steel plate includes an electroplating method and an electroless plating method. The Sn plating layer can be formed by any of these methods in the present invention. The electroplating method includes an electroplating method using a Sn plating bath such as a methanesulfonic acid bath, a Ferrostan bath or a halogen bath, and the like, and the present invention is not limited only to those exemplified ones. The adhesion amount of the Sn plating layer formed on the Cu plating layer is 1.5 to 15 g/m² from the viewpoint of improvement in abrasion resistance in fine sliding.

The plating layers made of the Cu plating layer and the Sn plating layer can be formed on only one surface of the stainless steel plate, or on both surfaces of the stainless steel plate in the present invention. In the above-mentioned plating layers, the Sn plating layer forms the outermost surface layer of the plating layers formed on the material for a connecting member of the present invention.

After the formation of the Sn plating layer on the stainless steel plate, it is preferred that a reflow treatment of the stainless steel plate is carried out by heating the stainless steel plate at the melting point of Sn or higher in order to inhibit generation of a whisker in the Sn plating layer.

As explained above, the material for a connecting member of the present invention can be produced by forming the Cu plating layer on the surface of the stainless steel plate, and then forming the Sn plating layer. Since the material for a connecting member of the present invention is excellent in abrasion resistance in fine sliding, the material can be suitably used in, for example, electrical contact members such as a connector, a lead frame and a harness plug, which are used in an electrical instrument, an electronic instrument, and the like.

### EXAMPLES

Next, the present invention is more specifically described based on working examples. However, the present invention is not limited only to those examples.

In the following working examples and comparative examples, three kinds of a stainless steel plate having a thickness of 0.2 mm were used. Chemical components of each stainless steel plate are shown in Table 1.

TABLE 1

| Kind of | | | | | | | | |
|---|---|---|---|---|---|---|---|---|
| Stainless | Kind of | Chemical components (% by mass) | | | | | | |
| steel | Steel | C | Si | Mn | P | S | Ni | Cr |
| A | SUS410 | 0.054 | 0.48 | 0.38 | 0.033 | 0.001 | 0.20 | 12.49 |
| B | SUS430 | 0.069 | 0.52 | 0.33 | 0.028 | 0.002 | 0.14 | 17.42 |
| C | SUS304 | 0.070 | 0.50 | 0.78 | 0.029 | 0.007 | 8.05 | 18.20 |

### Examples 1 to 12 and Comparative Examples 1 to 10

An annealing and acid washing treatment and a cold rolling treatment were repeatedly conducted to each of the stainless steel plates A, B and C under various conditions, to give stainless steel plates having a surface hardness as shown in Table 2. The surface hardness of the stainless steel was determined in accordance with the following method after a material for a connecting member was produced.

Each stainless steel plate was cut so as to have a size of 110 mm in length and 300 mm in width, and the stainless steel plate was subjected to alkali degreasing and acid washing by a conventional method.

When a Ni strike plating layer was formed on the stainless steel plate, the Ni strike plating was carried out under the following conditions for Ni strike plating by dipping the stainless steel plate in a Wood's bath, and applying a current to the bath so as to form a Ni plating layer having a deposition amount of 0.9 g/m².

[Conditions for Ni strike plating]

Ni plating solution (Wood's bath): 240 g/L of nickel chloride and 125 mL/L of hydrochloric acid (pH: 1.2)

Temperature of plating solution: 35° C.

Current density: 8 A/dm²

In the column “Employment of Ni strike plating” shown in Table 2, the term “no” means that Ni strike plating was not carried out, and the term “yes” means that Ni strike plating was carried out.

Next, the above-mentioned stainless steel plate was dipped in a sulfonic acid bath, and Cu plating was carried out under the following conditions for Cu plating, to form a Cu plating layer having a deposition amount as shown in Table 2. Thereafter, the stainless steel plate was dipped in a methanesulfonic acid bath, and Sn plating was carried out under the following conditions for Sn plating, to form a Sn plating layer having a deposition amount as shown in Table 2. As a result, a material for a connecting member was produced.

[Conditions for Cu Plating]

Cu plating solution (copper sulfate plating bath): 200 g/L of copper sulfate and 45 g/L of sulfuric acid

Temperature of plating solution: 30° C.

Current density: 15 A/dm²

[Conditions for Sn Plating]

Sn plating solution (methanesulfonic acid bath): Sn²⁺ 50 g/L, free acid 120 mL/L (pH: 0.2)

Temperature of plating solution: 30° C.

Current density: 10 A/dm²

Next, a reflow treatment of the material for a connecting member obtained in the above was carried out by heating the material for a connecting member at a melting point of Sn or higher, to give a material for a connecting member in which a reflow treatment was conducted to the stainless steel plate. In the column “Employment of reflow treatment” shown in Table 2, the term “yes” means that the reflow treatment was carried out, and the term “no” means that the reflow treatment was not carried out.

The material for a connecting member obtained in the above was cut to give a test piece for determining the deposition amount of a plating layer of the material for a connecting member, a test piece for determining surface hardness of the stainless steel plate, and a test piece for determining abrasion resistance in fine sliding of the material for a connecting member.

Each deposition amount of a Ni plating layer, a Cu plating layer and a Sn plating layer of the material for a connecting member obtained in the above was determined in accordance with the following determining method of deposition amount of a plating layer. Its results are shown in Table 2.

[Determining Method of Deposition Amount of a Plating Layer]

The test piece for determining the deposition amount of a plating layer obtained in the above was dipped in sulfuric acid to dissolve each plating layer in the sulfuric acid, to obtain a solution. The solution was used to determine a deposition amount of an element contained in the deposition layer, and the deposition amount was determined by means of an inductively coupled plasma (ICP) emission spectroscopy commercially available from Shimadzu Corporation under a product number of ICPS-8100.

The surface hardness of the stainless steel plate used in the material for a connecting member obtained in the above was determined in accordance with the following method for determining a surface hardness of the stainless steel plate. Its results are shown in Table 2.

[Method for Determining a Surface Hardness of the Stainless Steel Plate]

As a test piece for determining a surface hardness of the stainless steel plate obtained in the above, a rectangular test piece having a size of 25 mm in length and 15 mm in width was used. The test piece was embedded in an epoxy resin, and the epoxy resin was cured to give an embedded product. The embedded product was cut, and its cut section was polished to form a mirror plane by means of an automatic polishing device.

Next, a Vickers hardness of the polished surface of the test piece was determined within a range from the surface of the stainless steel plate to the depth of 15 μm from the surface in the central direction of the thickness of the plate under a load of 10 g at arbitrary 5 points by means of a Micro Vickers Hardness Tester (product number: HM-221) commercially available from Mitutoyo Corporation, and its average was regarded as a surface hardness of the stainless steel plate.

Next, abrasion resistance in fine sliding of the material for a connecting member was determined in accordance with the following determining method of abrasion resistance in fine sliding. Its results are shown in Table 2.

[Determining Method of Abrasion Resistance in Fine Sliding]

The test piece for determining abrasion resistance in fine sliding of the material for a connecting member obtained in the above was cut to give a rectangular substrate plate having a size of 5 mm in length and 40 mm in width, and a rectangular test piece having a size of 5 mm in width and 10 mm in length.

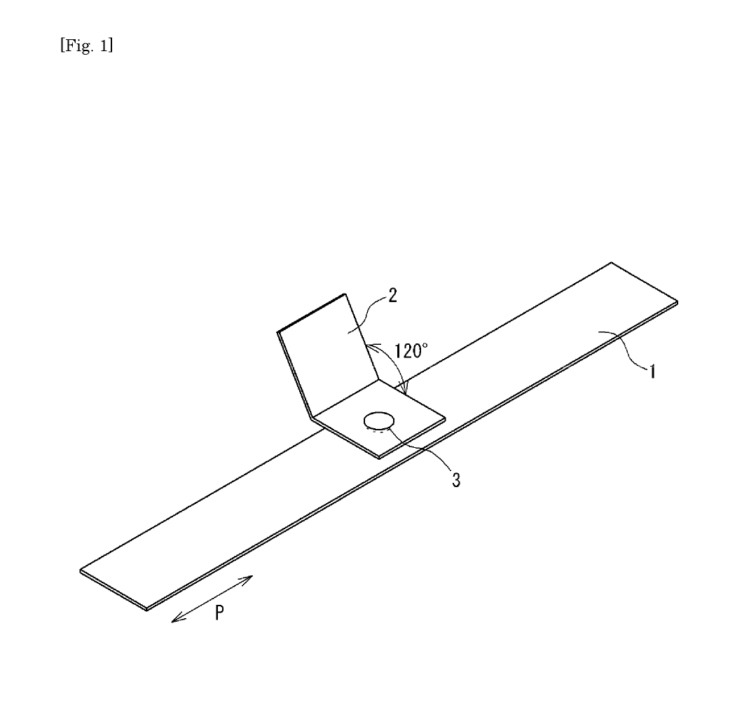

The abrasion resistance in fine sliding was determined by using a sliding tester (product number: CRS-G2050) manufactured by Kabushikikaisha Yamasaki Seiki Kenkyusho, and arranging the substrate plate 1 and the test piece 2 in the sliding tester as shown in FIG. 1. Incidentally, FIG. 1 is a schematic explanatory view of an apparatus used in examining abrasion resistance in fine sliding.

More specifically, a hemispherical convex 3 having a radius of 1.2 mm and a maximum depth of 0.3 mm was formed at the central portion of one half of the test piece 2, and then the test piece 2 was folded so that a bending angle between one half portion and another half portion became 120°. The surface of the substrate plate 1 was contacted with the top of the convex 3 of the test piece 2, and contacting pressure between the substrate plate 1 and the convex 3 was adjusted to 3.0 N by pressing the test piece 2 with a spring (not shown in the figure). While the contacting pressure was maintained to 3.0 N, the substrate plate 1 was slid as shown by an arrow P in a moving distance of 100 μm when the substrate plate 1 was reciprocated in a longitudinal direction. At that time, a sliding procedure for reciprocating the substrate plate 1 one time from the initiated sliding position was regarded as one cycle. The sliding procedure was carried out for one cycle, 200 cycles and 400 cycles. Thereafter, an electric current of 10 mA was applied between the substrate plate 1 and the test piece 2, and change of voltage between the substrate plate 1 and the test piece 2 was determined by a four-terminal sensing method. The contact resistance was calculated based on the equation: [Contact resistance]=[Voltage which was detected]÷[Current which was applied], and the abrasion resistance in fine sliding was evaluated in accordance with the following evaluation criteria:

(Evaluation Criteria)

⊚: Each of the difference between the resistance after one cycle of the sliding procedure and the resistance after 200 cycles of the sliding procedure, and the difference between the resistance after one cycle of the sliding procedure and the resistance after 400 cycles of the sliding procedure is 10 mΩ or less, respectively.
∘: The difference between the resistance after one cycle of the sliding procedure and the resistance after 200 cycles of the sliding procedure is 10 mΩ or less, and the difference between the resistance after one cycle of the sliding procedure and the resistance after 400 cycles of the sliding procedure exceeds 10 mΩ.
x: The difference between the resistance after one cycle of the sliding procedure and the resistance after 200 cycles of the sliding procedure exceeds 10 mΩ, regardless the difference between the resistance after one cycle of the sliding procedure and the resistance after 400 cycles of the sliding procedure.

TABLE 2

| | | | Deposition amount of | | | | |
|---|---|---|---|---|---|---|---|
| | | | plating layer (g/m²) | | | Surface | |
| Ex. and | Kind of | Employment | Cu | Sn | Employment | hardness | Abrasion |
| Comp. Ex. | stainless | of Ni strike | plating | plating | of reflow | of steel | resistance in |
| No. | steel plate | plating | layer | layer | treatment | plate (HV) | fine sliding |
| Ex. 1 | A | Yes | 4.5 | 7.3 | Yes | 235 | ⊚ |
| Ex. 2 | B | Yes | 4.5 | 7.3 | Yes | 230 | ⊚ |
| Ex. 3 | C | Yes | 4.5 | 7.3 | No | 232 | ◯ |
| Ex. 4 | A | Yes | 45 | 3.6 | Yes | 213 | ⊚ |
| Ex. 5 | B | Yes | 45 | 7.3 | Yes | 210 | ⊚ |
| Ex. 6 | C | No | 1.9 | 14.7 | Yes | 340 | ⊚ |
| Ex. 7 | A | Yes | 22 | 7.3 | No | 202 | ◯ |
| Ex. 8 | B | Yes | 22 | 7.3 | Yes | 310 | ⊚ |
| Ex. 9 | A | Yes | 1.5 | 1.5 | Yes | 250 | ⊚ |
| Ex. 10 | B | No | 22 | 14.7 | Yes | 280 | ⊚ |
| Ex. 11 | B | Yes | 45 | 14.7 | Yes | 390 | ⊚ |
| Ex. 12 | C | No | 45 | 3.6 | Yes | 235 | ⊚ |
| Comp. Ex. 1 | A | Yes | 45 | 3.6 | Yes | 190 | X |
| Comp. Ex. 2 | B | Yes | 2.7 | 3.6 | Yes | 180 | X |
| Comp. Ex. 3 | C | Yes | 22 | 7.3 | Yes | 120 | X |
| Comp. Ex. 4 | A | Yes | 2.7 | 3.6 | Yes | 430 | X |
| Comp. Ex. 5 | B | Yes | 4.5 | 3.7 | Yes | 450 | X |
| Comp. Ex. 6 | C | Yes | 4.5 | 7.3 | No | 480 | X |
| Comp. Ex. 7 | A | Yes | 1.4 | 7.3 | Yes | 231 | X |
| Comp. Ex. 8 | B | Yes | 1.3 | 10 | Yes | 240 | X |
| Comp. Ex. 9 | C | Yes | 9 | 1.1 | Yes | 301 | X |
| Comp. Ex. 10 | B | Yes | Not | 7.3 | Yes | 232 | X |
| | | | existed | | | | |

From the results shown in Table 2, it can be seen that the material for a connecting member obtained in each working example is more excellent in abrasion resistance in fine sliding than the material for a connecting member obtained in each comparative example.

### Referential Example 1

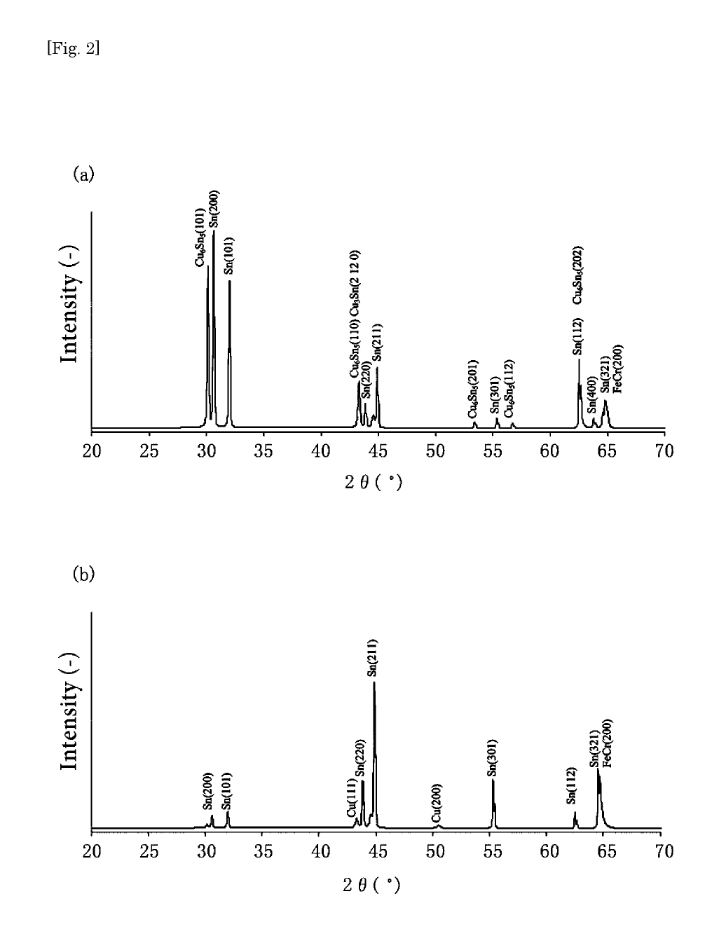

The X-ray diffraction of each plating layer of the material for a connecting member obtained in Example 1 and the material for a connecting member obtained in Example 3 was determined by means of an X-ray diffraction instrument commercially available from Rigaku Corporation under the product number of RINT2500 [X-ray: Cukα, tube voltage: 40 kV, tube current: 100 mA, step width: 0.02°, measuring speed: 4°/min]. Its results are shown in FIG. 2. FIG. 2 (a) is an X-ray diffraction pattern of the plating layer of the material for a connecting member obtained in Example 1, and FIG. 2 (b) is an X-ray diffraction pattern of the plating layer of the material for a connecting member obtained in Example 3.

From the results shown in FIG. 2, according to the material for a connecting member obtained in Example 1, it can be seen that an intermetallic compound of Cu and Sn is formed since the reflow treatment was carried out. In contrast, according to the material for a connecting member obtained in Example 3, it can be seen that an intermetallic compound of Cu and Sn is not formed since the reflow treatment was not carried out.

In addition, from the results shown in FIG. 2, the material for a connecting member obtained in Example 1 and the material for a connecting member obtained in Example 3 exhibit excellent abrasion resistance in fine sliding. Accordingly, it can be seen that the material for a connecting member exhibits excellent abrasion resistance in fine sliding, regardless of the formation of an intermetallic compound due to the reflow treatment.

### INDUSTRIAL APPLICABILITY

The material for a connecting member of the present invention is expected to be used in, for example, electrical contact members such as a connector, a lead frame and a harness plug, which are used in an electrical instrument, an electronic instrument, and the like.

### DESCRIPTION OF THE REFERENCE NUMERALS

1: Substrate plate
2: Test piece
3: Convex of test piece

1. A material for a connecting member used as a raw material of a connecting member, comprising a Cu plating layer formed on a surface of a stainless steel plate, and a Sn plating layer formed on the Cu plating layer, wherein the deposition amount of the Cu plating layer is 1.5 to 45 g/m²; the deposition amount of the Sn plating layer is 1.5 to 15 g/m²; and the surface hardness of the stainless steel plate is 200 to 400 HV.

2. A process for producing for a connecting member used as a raw material of a connecting member, comprising: forming a Cu plating layer on a surface of a stainless steel plate having a surface hardness of 200 to 400 HV so that the deposition amount of the Cu plating layer is 1.5 to 45 g/m², and forming a Sn plating layer on the Cu plating layer so that the deposition amount of the Sn plating layer is 1.5 to 15 g/m².
